(19) United States
(12) Patent Application Publication
(10) Pub. No.: US 2006/0026609 A1
(43) Pub. Date: Feb. 2, 2006

(54) Apparatus and method of releasing disk in optical disk player

(75) Inventor: Jung-jae Lee, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/186,796

(22) Filed: Jul. 22, 2005

(30) Foreign Application Priority Data
Jul. 29, 2004 (KR) 2004-59833

(51) Int. Cl. G11B 17/04

(52) U.S. Cl. 720/622

(57) ABSTRACT

Disclosed are an apparatus and method of releasing a disk. The disk releasing apparatus includes a first unit operating in cooperation with the second pivot plate to selectively couple the slider to the transmission unit, and a second unit operating in cooperation with the slider to release the second pivot plate from the disk. It can reduce the number of components, and decrease a power loss generated at the transmission.

### CROSS-REFERENCE TO RELATED APPLICATIONS

This application claims benefit under 35 U.S.C. § 119(a) from Korean Patent Application No. 2004-59833, filed on Jul. 29, 2004, the entire contents of which are incorporated herein by reference.

### BACKGROUND OF THE INVENTION

1. Field of the Invention

The present invention relates to an optical disk player. More particularly, the present invention relates to an apparatus and method of releasing a disk loading guide member away from the loaded disk.

2. Description of the Related Art

In general, a disk drive operates to record/reproduce information to/from a disk-shaped medium such as CD, DVD, DVD-ROM or the like. The disk drive includes a loading unit for loading the disk into a certain position at which information is recorded/reproduced to/from the disk. After the disk is inserted into a body of the disk player by means of the loading unit, the disk is positioned on a turntable, and is then clamped by a chucking unit to be ready for rotating. During rotation of the disk on the turntable, an optical pickup moves in a radial direction of the disk to record the information to the disk or reproduce the information from the disk.

In particular, due to miniaturization and spatial limitations of the disk player, a disk loading unit was recently employed to directly load the disk without a disk tray. In addition, another disk loading unit capable of loading disks of different sizes, such as 80 mm or 120 mm, is utilized.

A process of releasing the disk loaded into a chucking position from the guide member will now be described with reference to the accompanying drawings.

FIG. 1 is a top view depicting a disk of 120 mm (hereinafter referred to as the first disk) loaded into the chucking position. Referring to FIG. 1, the first disk 1 is loaded into the chucking position, with it pushing first and second guide pins 13b and 14a each formed at first and second guide levers 13 and 14. The loaded disk 1 pushes and rotates the left end of a pushing lever 15. Then, the right end of the pushing lever 15 pushes a slider 20 in direction B. When the slider is moved in direction B, as shown in FIG. 2, a drive gear 4 which idles before it is rotated by a motor (not shown) meshes with a rack gear 21 of the slider 20. Therefore, the slider 20 is continuously moved in the direction B in cooperation with the drive gear 4 and the rack gear 21.

As shown in FIG. 3, the guide pin 23 of the slider 20 moving in direction B is moved along a cam groove 16a of a sliding member 16 to operate the sliding member 16 on a right side thereof. While the sliding member 16 is moved on the right side, the predetermined shape of a flange 16b contacts and pushes a guide pin 12c provided at a right end of a locking lever 12 to release a locking boss 12b from a second locking groove 13c. A guide pin 14b of the second guide lever 14 is guided along a cam groove 16c of the sliding member 16. As the first and second guide levers 13 and 14 are further rotated by the cooperation with each other, the guide pins 13b and 14a are spaced apart from the disk 1. The pushing lever 15 is pushed by the slider 20, which is spaced apart from the disk 1.

A process of loading a disk of 80 mm (hereinafter referred to as second disk) will now be described with reference to the accompanying drawings.

Referring to FIGS. 4 and 5, a second disk 2 is loaded into the chucking position, with it pushing a guide pin 17a. If the guide pin 17a is pushed, a first interlocking lever 17 is rotated in a direction C around the guide pin 14a, and a second interlocking lever 18 is rotated in a direction D by a second pin 17b. A pin 15a of the pushing lever 15 is pulled by the second interlocking lever 18, such that the slider 20 is pushed in direction B for a certain distance. As such, the slider 20 is moved in direction B by the drive gear 4, as shown in FIG. 2. The sliding member 16 is moved to the right side in cooperation with the guide pin 23 of the slider 20, as shown in FIG. 5. The guide pin 12c of the locking lever 12 is rotated by the sliding member 16, so that the locking boss 12b is released from the first locking groove 13a. The guide pin 14c of the second guide lever 14 is guided along the cam groove 16c of the sliding member 16 for a certain distance, so that the first and second guide levers 13 and 14 are rotated relative to each other at a certain angle. As such, each of the guide pins 13b and 14a is spaced apart from the disk 2.

In addition, when each of the guide pins 13b and 14a is spaced apart from the first or second disk 1 or 2, the chucking lever 30 is moved down in cooperation with the slider 20, such that the first or second disk 1 and 2 is chucked onto the turntable.

A conventional disk loading unit configured as described above includes the first interlocking lever 17, the second interlocking lever 18 and the pushing lever 15 to cause the slider 20 to be cooperatively operated to release each guide pins 13b and 14a from the disk 1 or 2 loaded into the chucking position. This construction requires many components. In particular, since it is required for many interlocking members to cooperatively operate the slider 20, there are some problems of increased power consumption and the possibility of malfunction.

In addition, the sliding member 16 is utilized to release each guide pin 13b and 14a from the first or second disk 1 or 2. Since the sliding member 16 is large and ineffectively transfers power, the transfer of power from the slider 20 to the guide levers 13 and 14 and the locking lever 12 requires considerable power.

### SUMMARY OF THE INVENTION

Additional aspects and/or advantages of the invention will be set forth in part in the description which follows and, in part, will be apparent from the description, or may be learned by practice of the invention.

An aspect of the present invention is to solve the problems inherent to a conventional disk player, and to provide an apparatus and method of releasing a guide member away from a loaded disk, with a reduced number of components, decreased power consumption and no malfunctions.

In order to achieve the above and other aspects, there is provided an apparatus for releasing disk guide units from a disk moved into a chucking position of a disk loading unit to rotate the disk, the disk loading unit including a first pivot plate, a second pivot plate, a slider, and a transmission unit coupled to a drive motor, which are installed to a main chassis, the apparatus comprising: a first unit operating in cooperation with the second pivot plate to selectively couple the slider to the transmission unit; and a second unit operating in cooperation with the slider to release the second pivot plate from the disk.

The apparatus may further include a third unit pivotally installed to the main chassis for selectively locking the second pivot plate.

The apparatus may further include a resilient member for coupling the locking lever and the releasing lever to resiliently bias the locking lever and the releasing lever.

In an exemplary embodiment of the present invention, the first unit includes a pushing lever pivotally installed to the main chassis for coupling the slider to the transmission unit in cooperation with the second pivot plate. Also, the second unit includes a releasing lever pivotally installed to the main chassis for releasing the second pivot plate from the disk in cooperation with the slider. With the above construction, the number of interlocking members required to couple the slider to the transmission unit can be reduced. Also, the malfunction of the releasing apparatus due to the decreased number of the interlocking member can be decreased. The disk player can be miniaturized because of the reduced number of components. Furthermore, the power is transferred from the slider to the second pivot plate by a leverage principle of the releasing lever, thereby decreasing the loss of the power.

According to another aspect of the present invention, there is provided a disk releasing method including: rotating a second pivot plate installed to a main chassis using a disk; coupling a pushing lever installed to the main chassis to the second pivot plate to move a slider installed to the main chassis in cooperation with the second pivot plate; and rotating the second pivot plate using a releasing lever installed to the main chassis in cooperation with the slider.

The method may further include coupling the slider to a transmission unit using the second pivot plate, the transmission unit installed to the main chassis and coupled to a drive motor; and moving the slider by coupling the slider to the transmission unit driven by the drive motor.

### BRIEF DESCRIPTION OF THE DRAWINGS

The above aspects and features of the present invention will be more apparent by describing certain embodiments of the present invention with reference to the accompanying drawings, in which:

FIG. 1 is a diagrammatic plan view of a conventional disk loading unit;

FIG. 2 is a right side view of a conventional disk loading unit;

FIG. 3 is a plan view illustrating a process of releasing a guide pin from a disk of 120 mm;

FIGS. 4 and 5 are plan views illustrating a process of releasing a guide pin from a disk of 80 mm;

FIG. 6 is a diagrammatic plan view of a disk loading unit according to an embodiment of the present invention;

FIG. 7 is a right side view of a disk loading unit according to an embodiment of the present invention;

FIGS. 8 and 9 are plan views illustrating a process of releasing a guide pin from a disk of 120 mm according to an embodiment of the present invention; and

FIGS. 10 though 12 are plan views illustrating a process of releasing a guide pin from a disk of 80 mm according to an embodiment of the present invention.

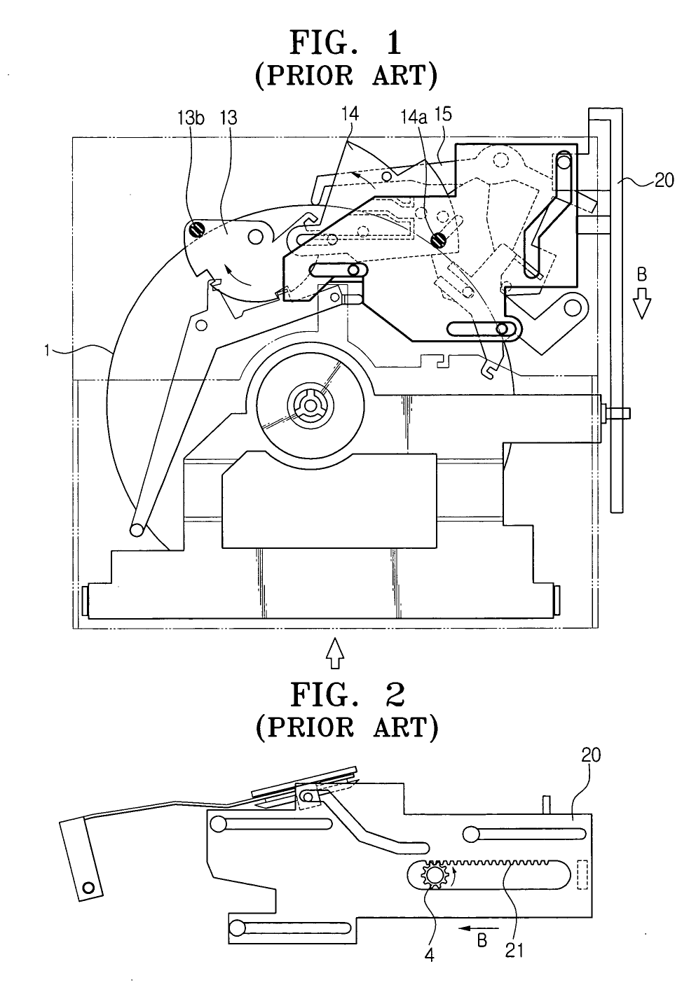

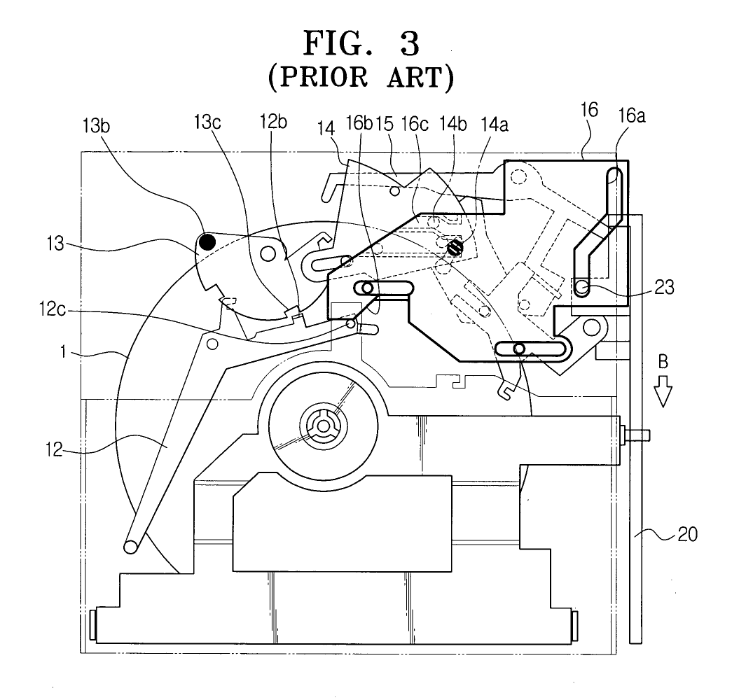

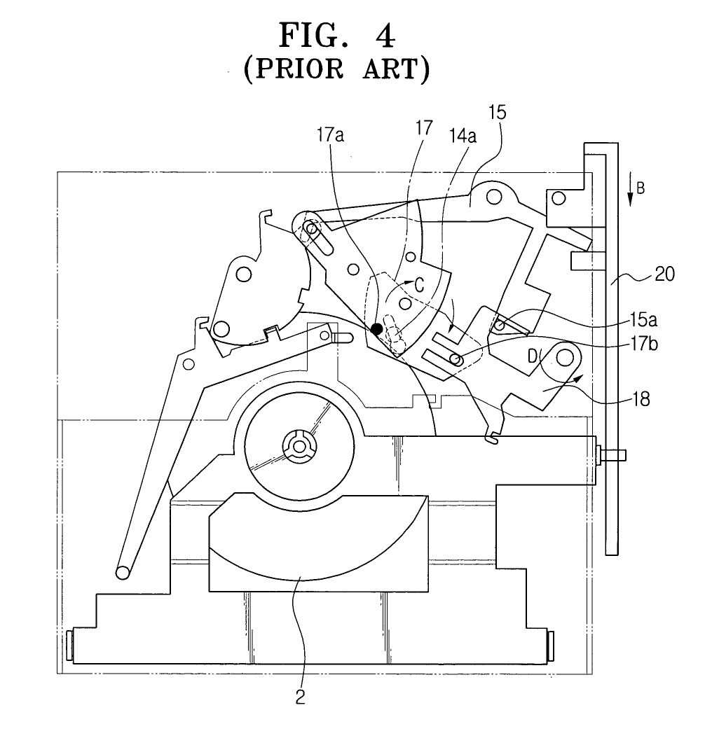

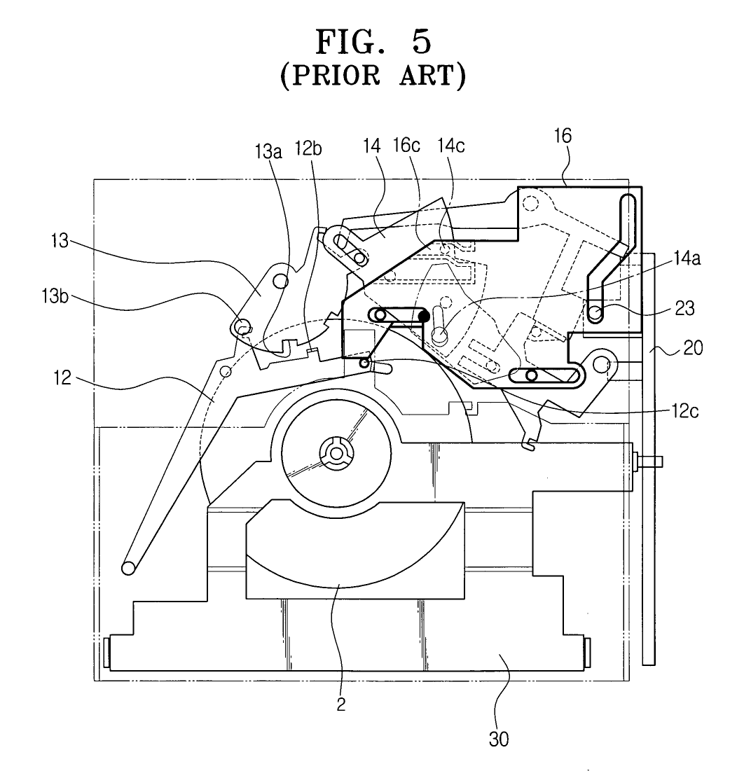

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

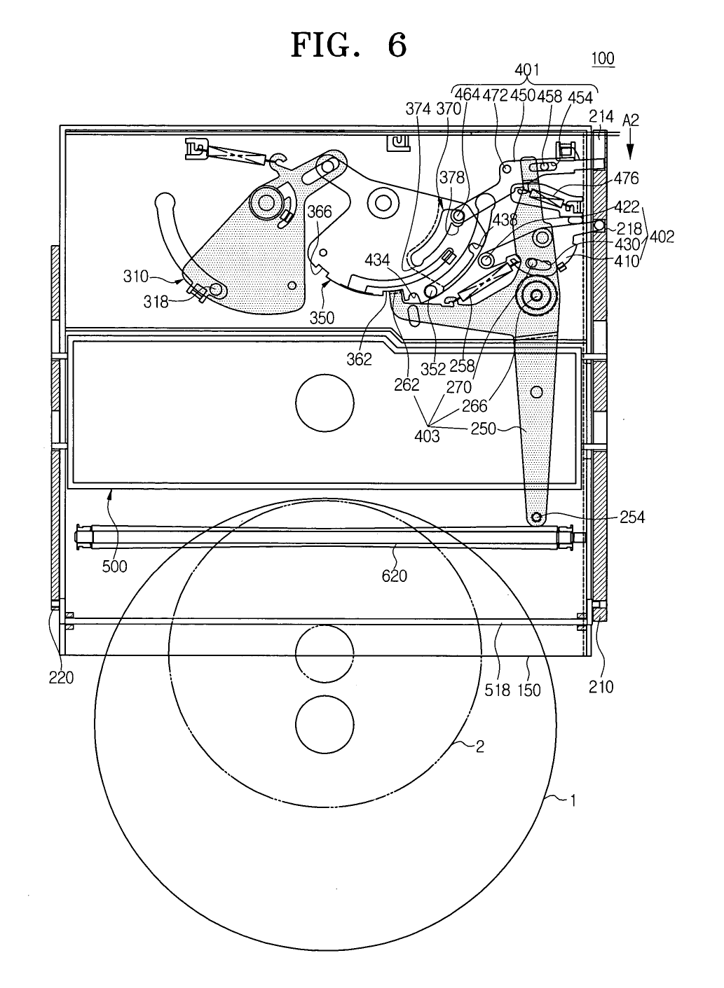

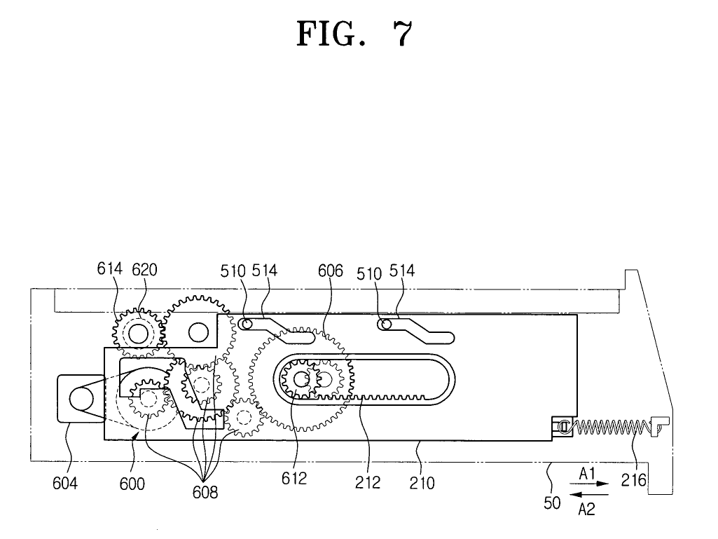

Referring to FIGS. 6 and 7, a disk releasing apparatus 100 for a disk player according to an embodiment of the present invention includes a first unit 401, a second unit 402, a third unit 403, and a resilient member 258. The disk releasing apparatus 100 operates to release each of first and second guide pins 318 and 352 provided at first and second pivot plates 310 and 350 from a disk 1 or 2 loaded into a chucking position. Other components include a main chassis 150, first and second sliders 210 and 220, and a transfer roller 620 for transferring the disk.

The first unit 401 includes a pushing lever 450, a guide pin 464, a slit 454, a pivot shaft pin 458, a contact pin 472, and a spring 476. The pushing lever 450 is pivotally installed to the main chassis 150. The guide pin 464 is provided at one end of the pushing lever 450, and is inserted into a guide slit 370 formed at a second pivot plate 350, so that it is moved along the guide slit 370. In addition, the pushing lever 450 is coupled to one end of the spring 476, while the other end of the spring 476 is coupled to the main chassis 150.

The slit 454 is formed at a center of the pushing lever 450, and the pivot shaft pin 458 installed to the main chassis 150 is inserted into the slit 454. The slit 454 is extended in a longitudinal direction, so that the pushing lever 450 can rotate around the pivot shaft pin 458. In addition, since the pivot shaft pin 458 is guided along the slit 454, the pushing lever 450 can linearly move. The contact pin 472 is provided at the center of the pushing lever 450, and is positioned on a left side of the slit 454. The contact pin 472 is selectively contacted with one end of the locking lever 250 to linearly move the pushing lever 450. The pushing lever 450 is unlocked from a first locking portion 374 or a second locking portion 378 each formed at both ends of the guide slit 370 by linear movement of the pushing lever 450.

The pushing lever 450 causes the first slider 210 to couple to a transmission unit 600 in cooperation with rotation of the second pivot plate 350, thereby removing conventional first and second interlocking levers. Therefore, it can reduce the number of components, and due to reduction of the number of the interlocking members, it can decrease the power requirement and reduce malfunctions.

The second unit 402 includes a releasing lever 410, a releasing lever pin 422, and a cam groove 430. The releasing lever 410 is pivotally installed on the main chassis 150. One end of the releasing lever 410 is inserted into a second interlocking groove 218 formed on the first slider 210. The releasing lever pin 422 is provided at the other end of the releasing lever 410, and is inserted into first and second releasing grooves 434 and 438 to rotate the second pivot plate 350. The rotation of the second pivot plate 350 causes each of the first and second guide pins 318 and 352 to be released from the first or second disk 1 or 2 arrived at the chucking position. The cam groove 430 is formed at the center of the releasing lever 410. When the releasing lever 410 is rotated, the cam groove 430 rotates the locking lever 250 to unlock the second pivot plate 350 from the locking lever 250. The releasing lever 410 and the locking lever 250 are coupled to each other through the resilient member 258. The resilient member 258 serves to easily lock the locking lever 250 and to smoothly rotate and return the releasing lever 410 to perform the releasing function. In addition, the rotation of the releasing lever 410 causes the second pivot plate 350 to rotate using a leverage principle, thereby reducing power consumption.

The third unit 403 includes the locking lever 250, a locking boss 262, a locking lever pivot shaft 266, and a cam boss 270. The locking lever 250 is pivotally installed to the main chassis 150. The locking lever 250 is provided at one end thereof with an interfering pin 254 which comes into contact with the first disk 1 injected into a housing 50. The interfering pin 254 is pushed by the first disk 1 injected to rotate the locking lever 250 and thus unlock the second pivot plate 350. The locking boss 262 is provided at an end of a lever extended from a center of the locking lever 250 to a left side thereof. The locking boss 262 is inserted into the first and second locking grooves 362 and 366 to selectively lock the second pivot plate 350. The pivot shaft 266 is provided at the center of the locking lever 250, and serves as a rotary center of the locking lever 250. The cam boss 270 is provided at the locking lever 250, and is positioned at a front of the pivot shaft 266. The cam boss 270 is inserted into the cam groove 430 formed at the releasing lever 410, so that when the releasing lever 410 is rotated, the cam boss 270 is moved along the cam groove 430 to rotate the locking lever 250.

The disks 1 and 2 are generally classified into the first disk 1 of 120 mm and the second disk 2 of 80 mm. The disk loading unit according the embodiment of the present invention is applied to a disk player capable compatibly loading disks of different sizes without a disk tray.

For reference, the main chassis 150 shown in FIG. 6 is installed in an upper portion of the housing 50 to which an optical pickup (not shown) is installed. The main chassis 150 is provided with a chucking unit 500 for chucking the disk 1 or 2 transferred into the chucking position onto a turntable (not shown). In addition, the transmission unit 600 shown in FIG. 7 includes a follower gear 614, a coupling gear 608, a main gear 606, and a driving gear 612. The follower gear 614 is provided at one side of the transferring roller 620 to rotate the transferring roller 620 and transfer the first and second sliders 210 and 220.

A process of releasing the disk of a disk player according to an embodiment of the present invention will now be described in detail.

First, a process of releasing the first and second guide pins 318 and 352 from the first disk 1 of 120 mm will now be described.

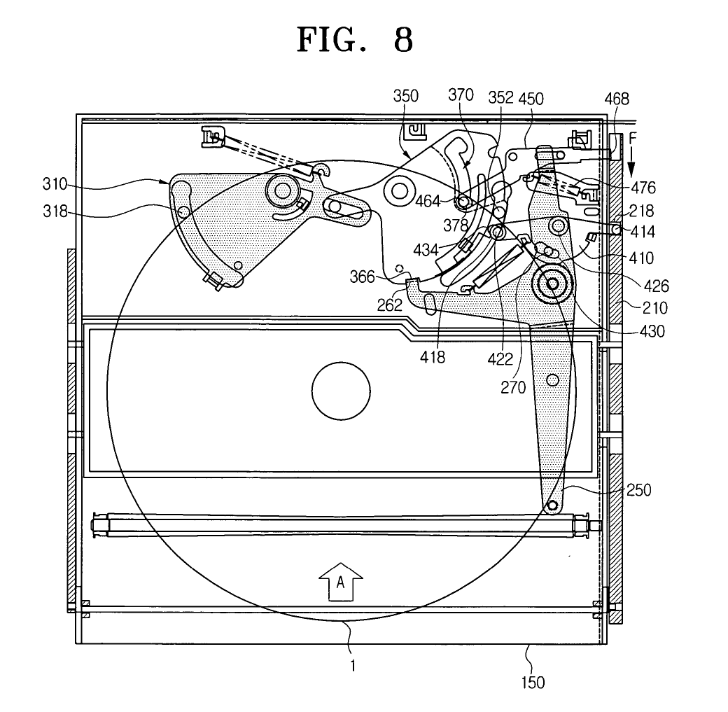

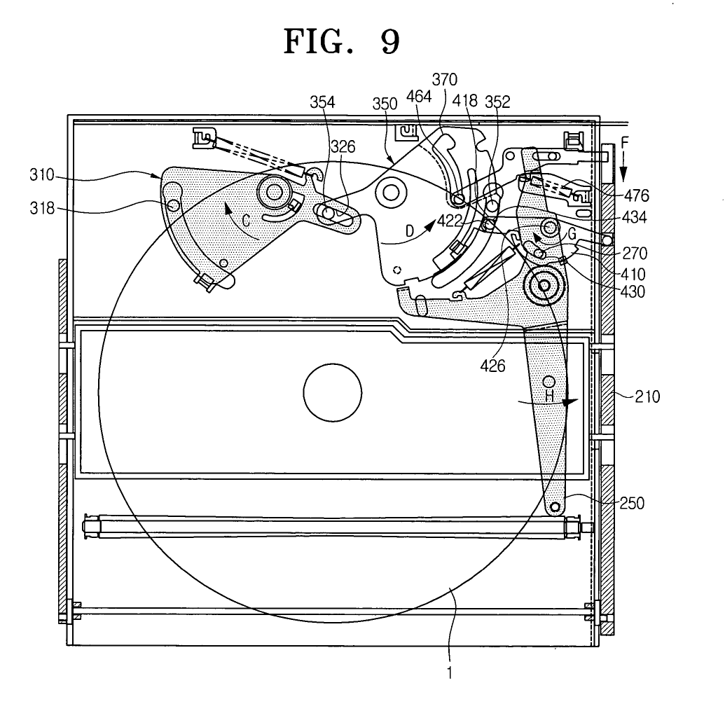

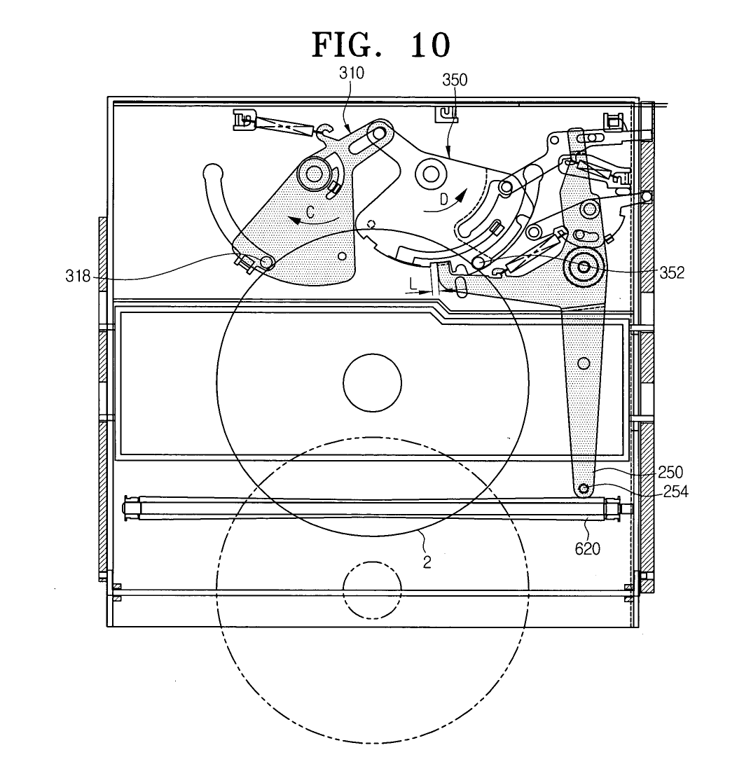

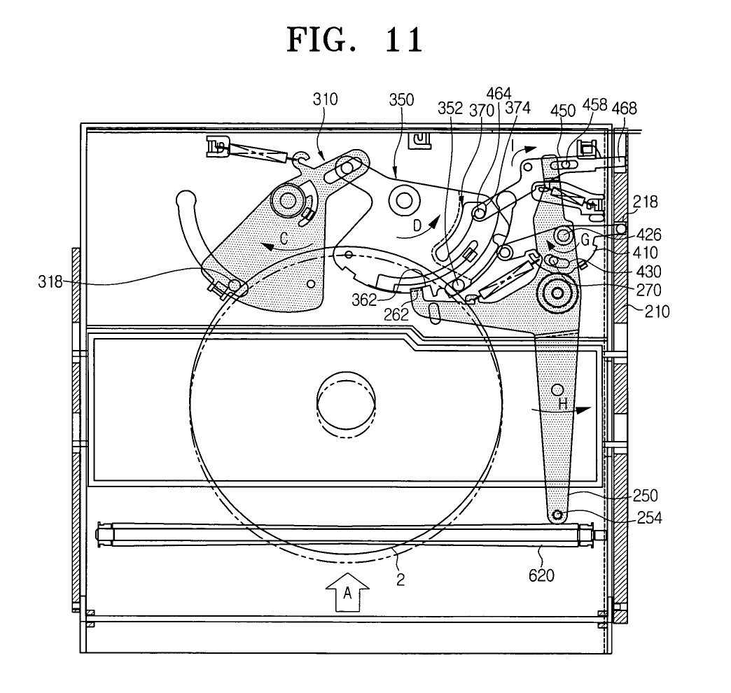

FIG. 8 is a plan view illustrating the first disk 1 loaded into the chucking position, and FIG. 9 is a plan view illustrating the first and second guide pins 318 and 352 released from the first disk 1.

Referring to FIGS. 8 and 9, the first disk 1 is guided by the first and second guide pins 318 and 352 provided at the first and second pivot plates 310 and 350, so that the first and second pivot plates 310 and 350 are rotated into the chucking position by the transferring roller 620 (FIG. 6).

At that time, as the guide pin 464 moves along the guide slit 370, the pushing lever 450 is positioned at the second locking portion 378 formed at the end of the guide slit 370. When the guide pin 464 of the pushing lever 450 is positioned at the second locking portion 378, the guide pin 464 is locked in the second locking portion 378 by a resilient force of the spring 476 installed on the pushing lever 450 and the main chassis 150. At that time, one end 468 of the pushing lever 450 is moved in direction F to push the first slider 210 in direction F. The rack gear 212 (FIG. 7) formed at the first slider 210 meshes with the drive gear 612 (FIG. 7), and the first slider 210 is moved in direction F by the motor 604 (FIG. 7) step S2)

When the first slider 210 is moved in direction F, the releasing lever 410 of which one end 414 is inserted into the second interlocking groove 218 formed in the first slider 210 is rotated in a direction G around a pivot shaft 426. When the releasing lever 410 is rotated in the direction G, the releasing lever pin 422 provided at the other end 418 of the releasing lever 410 is locked into the first releasing groove 434 formed at the second pivot plate 350. As the releasing lever 410 is rotated in direction G, the cam boss 270 formed at the locking lever 250 is moved along the cam groove 430 formed on the releasing lever 410. Specifically, the locking lever 250 is rotated in a direction H by the cam boss 270 of the locking lever 250 inserted into the cam groove 430, in cooperation with rotation of the releasing lever 410. The rotation of the locking lever 250 causes the second pivot plate 350 to unlock from the locking lever 250. At that time, the releasing lever pin 422 provided at the other end 418 of the releasing lever 410 is inserted into the first releasing groove 434 formed at the second pivot plate 350. Accordingly, the second pivot plate 350 which is unlocked by the releasing lever 410 rotated in the direction G is inserted into the first releasing groove 434 formed in the second pivot plate 350, and is rotated in direction D. As the second pivot plate 350 is rotated in direction D, the second guide pin 352 contacted with the first disk 1 is released from the first disk 1. A pin 354 formed on the second pivot plate 350 is interlocked with a hole 326 formed in the first pivot plate 310 by the second pivot plate 350 rotated in direction D, and the first pivot plate 310 rotates in direction C. As the first and second pivot plates 310 and 350 are rotated in directions C and D, respectively, the first and second guide pins 318 and 352 formed at the first and second pivot plates 310 and 350 contacted with the first disk 1 are released from the first disk 1.

Next, a process of releasing the first and second guide pins 318 and 352 from the second disk 2 of 80 mm will now be described.

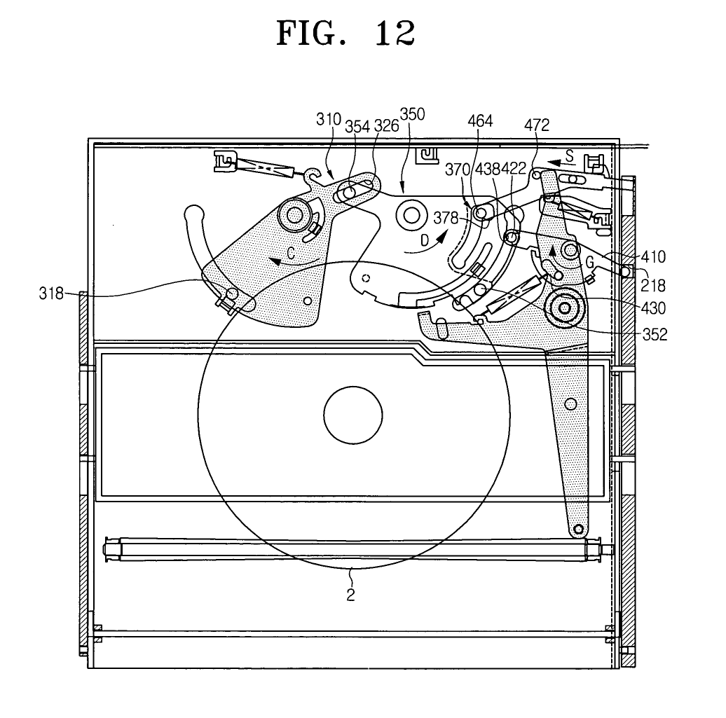

FIGS. 10 and 11 are plan views illustrating the second disk 2 loaded into the chucking position.

Referring to FIGS. 10 and 11, as the transferring roller 620 is rotated by the drive motor 604 (FIG. 7), the second disk 2 is pulled into the housing 50 (FIG. 7). The second disk 2 is further inserted, until it comes into contact with the first and second guide pins 318 and 352 of the first and second pivot plates 310 and 350. After that, the second disk 2 slightly further pushes the first and second guide pins 318 and 352 in the loading direction. As such, the first and second pivot plates 310 and 350 are rotated in the directions C and D, respectively. At that time, the locking boss 262 of the locking lever 250 is moved in the first locking groove 362 for a distance L. As shown in FIG. 11, the second disk 2 is completely loaded into the chucking position in the above process.

FIG. 12 is a plan view illustrating the first and second guide pins 318 and 352 spaced apart from the second disk 2.

Referring to FIG. 12, the first locking portion 374 formed at the other end of the guide slit 370 of the second pivot plate 350 pushes the guide pin 464 of the pushing lever 450 installed at the other end of the pushing lever 450. The pushing lever 450 is rotated in direction I on the basis of the pivot shaft pin 458 (FIG. 11). The rotation of the pushing lever 450 causes the one end 468 of the pushing lever 450 to push the first slider 210 in direction F. When the first slider 210 is pushed in direction F, as the rack gear 212 (FIG. 7) formed at the first slider 210 meshes with the drive gear 612 (FIG. 7), the first slider 210 pushed in direction F is moved in direction F by the drive motor 604 (FIG. 7).

When the first slider 210 is moved in direction F, the releasing lever 410 of which one end 414 is inserted into the second interlocking groove 218 formed in the first slider 210 is rotated in the direction G around the pivot shaft 426. As the releasing lever 410 is rotated in direction G, the cam boss 270 formed on the locking lever 250 is moved along the cam groove 430 formed in the releasing lever 410. Specifically, the locking lever 250 is rotated in the direction H by the cam boss 270 of the locking lever 250 inserted into the cam groove 430, in cooperation with rotation of the releasing lever 410. The rotation of the locking lever 250 toward the direction H causes the second pivot plate 350 to unlock from the locking lever 250. At that time, the releasing lever pin 422 provided at the other end 418 of the releasing lever 410 is inserted into the second releasing groove 438 formed in the second pivot plate 350. Further, the rotation of the releasing lever 410 toward direction G causes the locking lever 250 rotated in cooperation with the cam groove 430 formed in the releasing lever 410 to push the contact pin 472 in a direction S. As such, the guide pin 464 formed at one end of the pushing lever 450 is unlocked from the second unlocking portion 378 formed at the other end of the guide slit 370. Also, the unlocked second pivot plate 350 is rotated in the direction D in cooperation with the releasing lever 410, which is inserted into the second releasing groove 438 formed in the second pivot plate 350, rotated in the direction G. As the second pivot plate 350 is rotated in direction D, the second guide pin 352 contacted with the second disk 2 is spaced apart from the second disk 2. The pin 354 formed on the second pivot plate 350 is interlocked with a hole 326 formed in the first pivot plate 310 by the second pivot plate 350 rotated in the direction D, and the first pivot plate 310 allows the first pivot plate 310 to rotate in a direction C. As the first and second pivot plates 310 and 350 are rotated in directions C and D, respectively, the first and second guide pins 318 and 352 formed at the first and second pivot plates 310 and 350 contacted with the second disk 2 are released from the second disk 2.

The cam boss 510 (FIG. 7) formed at the chucking unit 500 (FIG. 6) cooperatively operates along the cam groove 514 (FIG. 7) formed at the first and second sliders 210 and 220 in non-linear time series with the above releasing operation, so that the chucking unit 500 moves down. As the chucking unit 500 moves down, the first or second disk 1 or 2 are seated on the turntable (not shown).

With the above description, according to the disk releasing apparatus of the present invention, the first and second guide pins can be spaced apart from a first or second disk of different sizes, thereby decreasing malfunctions of the releasing apparatus.

In addition, the number of interlocking members required to couple the slider to the transmission unit can be reduced. Also, the malfunction of the releasing apparatus due to the decreased number of the interlocking member can be decreased. The disk player can be miniaturized because of the reduced number of the components.

Furthermore, the power is transferred from the slider to the second pivot plate by a leverage principle of the releasing lever, thereby decreasing the loss of the power.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. An apparatus for releasing disk guide units from a disk moved into a chucking position of a disk loading unit to rotate the disk, the disk loading unit including a first pivot plate installed to a main chassis, a second pivot plate, a slider, and a transmission unit coupled to a drive motor, the apparatus comprising:
a first unit operating in cooperation with the second pivot plate to selectively couple the slider to the transmission unit; and
a second unit operating in cooperation with the slider to release the second pivot plate from the disk.

2. The apparatus of claim 1, wherein the first unit includes a pushing lever pivotally installed to the main chassis for coupling the slider to the transmission unit in cooperation with the second pivot plate.

3. The apparatus of claim 2, wherein the second unit includes a releasing lever pivotally installed to the main chassis, for releasing the second pivot plate from the disk in cooperation with the slider.

4. The apparatus of claim 3, further comprising a third unit pivotally installed to the main chassis, for selectively locking the second pivot plate.

5. The apparatus of claim 4, wherein the third unit includes a locking lever operating in cooperation with the releasing lever.

6. The apparatus of claim 5, wherein the releasing lever is formed with a cam groove, and the locking lever is provided with a cam boss moving along the cam groove to rotate the locking lever and unlock the second pivot plate.

7. The apparatus of claim 5, further comprising a resilient member for coupling the locking lever and the releasing lever to resiliently bias the locking lever and the releasing lever.

8. The apparatus of claim 2, wherein the first unit further includes a spring having one end installed to the pushing lever and the other end coupled to the main chassis, such that one-directional rotation of the pushing lever is resiliently biased.

9. A disk releasing method comprising:
rotating a second pivot plate installed to a main chassis using a disk;
coupling a pushing lever installed to the main chassis to the second pivot plate to move a slider installed to the main chassis in cooperation with the second pivot plate; and
rotating the second pivot plate using a releasing lever installed to the main chassis in cooperation with the slider.

10. The method of claim 9, wherein coupling a pushing lever comprises:
coupling the slider to a transmission unit using the second pivot plate, the transmission unit installed to the main chassis and coupled to a drive motor; and
moving the slider by coupling the slider to the transmission unit driven by the drive motor.

11. The method of claim 10, wherein rotating the second pivot plate comprises:
rotating the releasing lever in cooperation with the slider; and
releasing the second pivot plate from the disk in cooperation with the rotated releasing lever.

12. The method of claim 11, wherein rotating the second pivot plate further comprises rotating a locking lever pivotally installed to the main chassis using the releasing lever to unlock the second pivot plate from the locking lever.

13. A disk releasing apparatus for releasing guide pins from a disk moved into a chucking position of a disk loading unit, the disk loading unit comprising a first pivot plate installed to a main chassis, a second pivot plate, a slider, and a transmission unit coupled to a drive motor, the apparatus comprising:
a first unit operating in cooperation with the second pivot plate to selectively couple the slider to the transmission unit; and
a second unit operating in cooperation with the slider to release the second pivot plate from the disk.

14. The apparatus of claim 13, wherein the first unit comprises:
a pushing lever pivotally attached to the main chassis for coupling the slider to the transmission unit in cooperation with the second pivot plate; and
a first guide pin provided at one end of the pushing lever.

15. The apparatus of claim 13, wherein the second unit comprises:
a releasing lever pivotally attached to the main chassis, for releasing the second pivot plate from the disk in cooperation with the slider;
a guide slit formed in the second pivot plate;
a releasing lever pin provided at one end of the releasing lever; and
a cam groove formed at the center of the releasing lever,
wherein the first guide pin is inserted into a guide slit formed in the second pivot plate so that it is moved along the guide slit.

16. The apparatus of claim 13, further comprising a third unit pivotally attached to the main chassis for selectively locking the second pivot plate.

17. The apparatus of claim 16, wherein the third unit comprises:
a locking lever pivotally attached to the main chassis operating in cooperation with the releasing lever;
a cam boss centrally located on the locking lever;
a locking boss provided at one end of the locking lever to selectively lock the second pivot plate; and
an interfering pin provided at one end of the locking lever to come in contact with the disk.

18. The apparatus of claim 17, wherein the releasing lever further comprises:
a cam groove,
wherein the cam boss of the locking lever moves along the cam groove to rotate the locking lever and unlock the second pivot plate.

19. The apparatus of claim 17, further comprising a resilient member for coupling the locking lever to the releasing lever.

20. The apparatus of claim 14, wherein the first unit further comprises a spring,
wherein one end of the spring is attached to the pushing lever and the other end is attached to the main chassis.
